(19) United States
(12) Patent Application Publication
(10) Pub. No.: US 2011/0316314 A1
(43) Pub. Date: Dec. 29, 2011

(54) INTEGRATED ADJUSTABLE BACKREST AND STORAGE UNIT

(76) Inventor: Barry Brown, Marietta, GA (US)

(21) Appl. No.: 13/171,395

(22) Filed: Jun. 28, 2011

Related U.S. Application Data
(60) Provisional application No. 61/359,545, filed on Jun. 29, 2010.

(51) Int. Cl. B62J 1/28; A47C 7/62

(52) U.S. Cl. 297/188.05; 297/188.04; 297/188.06

(57) ABSTRACT

An integral unit that may serve as a backrest and a storage unit is provided. The integrated backrest and storage unit is configured such that a front surface of the integrated backrest and storage unit serves as a backrest for a driver of the two-wheel vehicle when the integrated backrest and storage unit is in a first position and the front surface serves as a back rest for a passenger of the two-wheel vehicle when the integrated backrest and storage unit is in a second position

### CROSS-REFERENCE TO RELATED APPLICATIONS

This application claims the benefit of U.S. Provisional Application Ser. No. 61/359,545, which was filed on Jun. 29, 2010, and is incorporated herein by reference in its entirety.

### FIELD

The present invention relates to an integrated adjustable backrest and storage unit.

### BACKGROUND

Existing two-wheel motor vehicles such as motorcycles and scooters can include backrest for a driver and a separate a storage unit. The backrest typically is not adjustable and provides inadequate support. Furthermore, the storage unit does not provide adequate storage space and is not aesthetically pleasing.

### BRIEF DESCRIPTION OF THE DRAWINGS

FIG. 1 illustrates an example adjustable backrest and storage unit for a two-wheel motor vehicle according to an exemplary embodiment of the present invention.

FIG. 2 illustrates the example adjustable backrest and storage unit of FIG. 1 moved in a backward direction.

FIG. 3 illustrates an example additional storage compartment attached to the example adjustable backrest and storage unit of FIG. 1.

### DETAILED DESCRIPTION

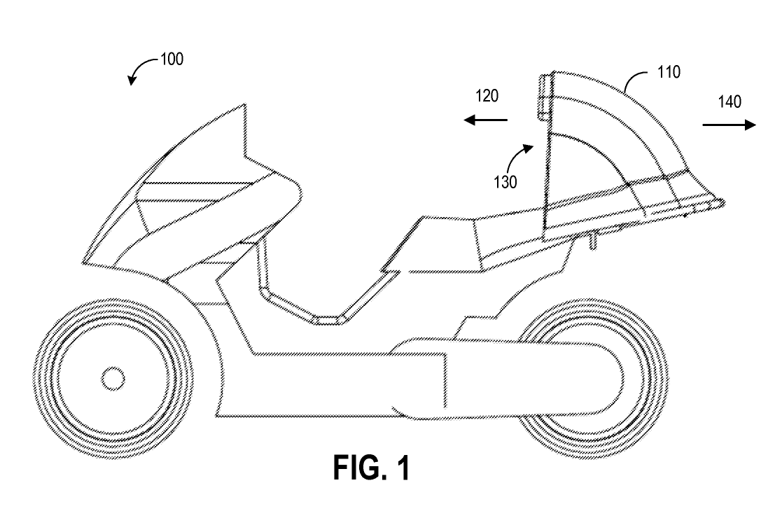

FIG. 1 illustrates an example adjustable backrest and storage unit 110 for a two-wheel motor vehicle 100 such as a motorcycle or scooter according to an exemplary embodiment of the present invention.

The unit 110 may be an integral unit that may serve as a backrest and a storage unit. The unit 110 may be any size and shape, and, in some embodiments, the unit 110 is designed to be functional yet aesthetically pleasing (for example, the unit 110 appears to be an integral part of the two-wheel motor vehicle). The unit 110 may be adjustable. For example, the unit 110 may be moved in a forward direction 120 or backward direction 140, for example via a sliding mechanism (not show), to a position comfortable for the driver. A portion, for example a front surface portion 130, of the unit 110 may serve as a backrest for the driver.

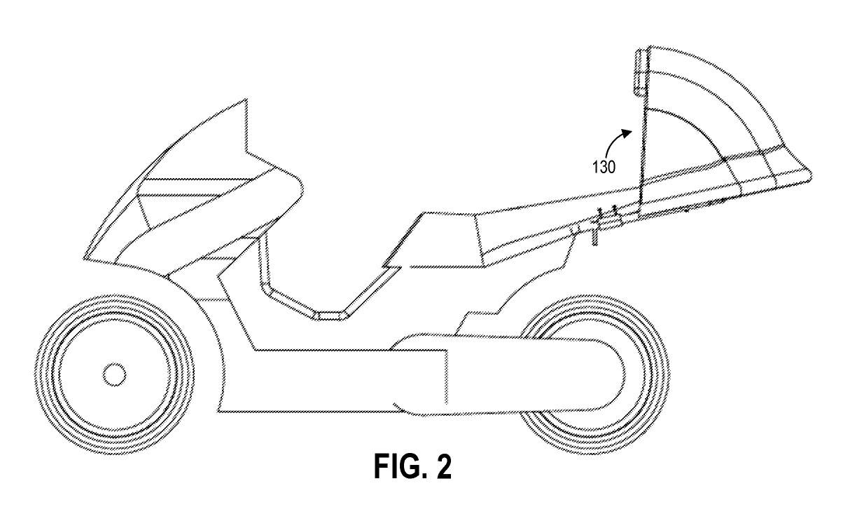

As shown in FIG. 2, if the driver is carrying a passenger on the vehicle 100, the unit 110 may be moved in a backward direction 140 away from the driver thereby allowing room for the passenger. In this configuration, portion 130 may serve as a backrest for the passenger.

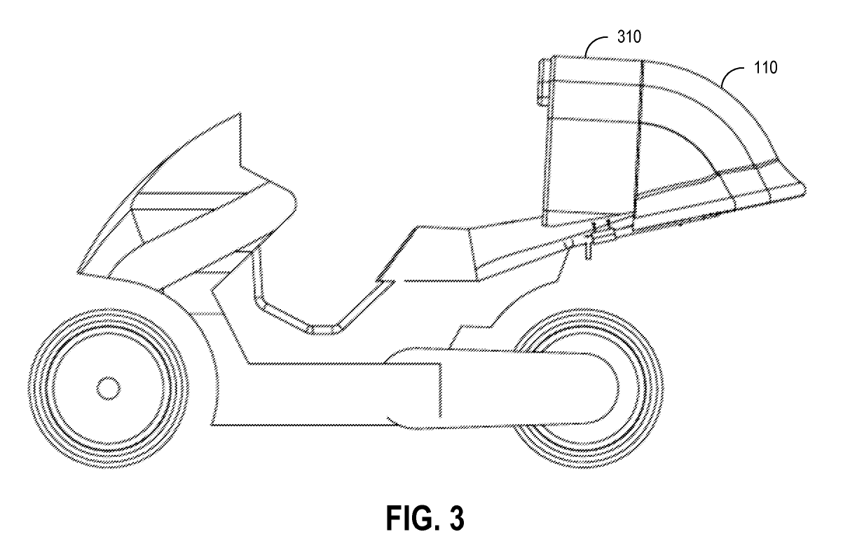

As shown in FIG. 3, in some embodiments, an additional storage compartment 310 may be attached to the unit 110.

One of ordinary skill in the art after disclosure of the present invention would know how to make and use unit 110 to function as described above.

Unit 110 also may include brake lights, tail lights, directional indicators (i.e., turn signals), any other light kits for any purpose, or any combination of the foregoing.

Because unit 110 may be larger than a typical storage unit 120, the inside area of the unit 110 may function not only as a storage area but also may serve numerous other functions. For example, unit 110 may house stereo speakers and/or a power supply. Unit 110 also may be used to house wired devices. With the wired device housed in the unit 110 behind the driver/passenger, the wires from the wired device to the driver/passenger (for example to the driver/passenger's helmet or apparel) may not obstruct the driver/passenger. Unit 110 also may be used to house wireless devices. Unit 110 may house easily accessible built in electrical connections for use with various items.

Unit 110 also may serve as a protected storage space for electrical components. Unit 110 also may serve as a communication system to enable the use on two-wheel vehicles of various technologies and/or devices such as wireless technology including GPS and Bluetooth technology, satellite technology, and alarm systems.

Unlike existing storage units, storage units for two-wheel vehicles according to embodiments of the present invention can integrate into the design of the vehicle to transform the look of the vehicle in an aesthetic way. For example, as shown in FIGS. 1 an 2, the unit 110 may aesthetically transform the look of the vehicle 100.

Embodiments of the present invention may be attached to a two-wheel vehicle either by the original equipment manufacturer (OEM) or in the after-market.

Embodiments of the present invention may be fabricated from plastics, metal, wood, and other material including, but not limited to, any combination of the forgoing, any lightweight, strong, and weather resistant material, and/or the same material used on parts of two-wheel vehicles. Embodiment of the present invention may be painted or chromed to resemble the appearance of the two-wheel vehicle.

Many modifications and other embodiments of the invention will come to mind to one skilled in the art to which this invention pertains having the benefit of the teachings presented in the forgoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Reference throughout this specification to “an embodiment,” “one embodiment”, or words of similar import means that a particular described feature, structure, or characteristic is included in at least one embodiment of the present invention. Thus, the phrase “in an embodiment” or a phrase of similar import in various places throughout this specification does not necessarily refer to the same embodiment.

Furthermore, the described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

What is claimed:

1. An apparatus comprising:
an integrated backrest and storage unit configured to engage with at least a portion of a seat area of a two-wheel vehicle such that a surface of the integrated backrest and storage unit serves as a backrest for a person when the person is positioned on the two-wheel vehicle as intended,
wherein the integrated backrest and storage unit includes a compartment for storage.

2. The apparatus of claim 1 wherein the integrated backrest and storage unit is configured such that a front surface of the integrated backrest and storage unit serves as a backrest for a driver of the two-wheel vehicle when the integrated backrest and storage unit is in a first position and the front surface serves as a back rest for a passenger of the two-wheel vehicle when the integrated backrest and storage unit is in a second position.

3. The apparatus of claim 2 wherein the integrated backrest and storage unit is configured to slideably engage in a length-wise direction with the at least a portion of a seat area of a two-wheel vehicle.

4. The apparatus of claim 1 further comprising a connectable storage compartment configured to attach to the front surface of the integrated backrest and storage unit, to provide additional storage, and to serve as a back rest for a person when the person is positioned on the two-wheel vehicle as intended.

5. A two-wheel vehicle comprising:
means for providing storage and backrest for one or more persons when the one or more persons are positioned on a two-wheel vehicle as intended.

6. A method for providing storage and a backrest for a two-wheel vehicle, the method comprising:
moving an integrated backrest and storage unit to a first position to provide a backrest for a driver of the two-wheel motor vehicle;
moving the integrated backrest and storage unit to a second position to provide a backrest for a passenger of the two-wheel motor vehicle; and
using the integrated backrest and storage unit for storage.
